(19) United States
(12) Patent Application Publication
(10) Pub. No.: US 2025/0148991 A1
(43) Pub. Date: May 8, 2025

(54) GATE DRIVER AND DISPLAY DEVICE INCLUDING THE SAME

(71) Applicant: Samsung Display Co., LTD., Yongin-si (KR)

(72) Inventor: EOK SU KIM, Yongin-si (KR)

(21) Appl. No.: 18/931,505

(22) Filed: Oct. 30, 2024

(30) Foreign Application Priority Data
Nov. 2, 2023 (KR) 10-2023-0149930

(51) Int. Cl. G09G 3/3266; G09G 3/32

(52) U.S. Cl. CPC G09G 3/3266; G09G 3/32; G09G 2300/0842; G09G 2310/0267

(57) ABSTRACT

A gate driver includes a plurality of stages. Each of the plurality of stages includes a common circuit which controls a voltage of a first control node, a voltage of a second control node, and a voltage of an inverted control node, and an individual circuit which outputs a plurality of scan signals in response to the voltage of the first control node and the voltage of the inverted control node. The individual circuit includes a plurality of scan buffer transistors which output a plurality of scan clock signals as the plurality of scan signals in response to the voltage of the first control node, and a scan hold transistor which maintains the plurality of scan signals at a first low voltage in response to the voltage of the inverted control node.

This application claims priority to Korean Patent Application No. 10-2023-0149930, filed on Nov. 2, 2023, and all the benefits accruing therefrom under 35 USC § 119, the content of which in its entirety is herein incorporated by reference.

### BACKGROUND

### 1. Field

The invention relates to a display device, and more particularly, to a display device which includes a gate driver having a reduced area.

### 2. Description of the Related Art

A display device may include a display panel and a panel driver. The display panel may include a plurality of pixels. The panel driver may include a data driver and a gate driver. The gate driver may generate gate signals applied to gate electrodes of transistors included in the pixels.

The gate driver may include a plurality of stages, where each of the stages may output a plurality of gate signals. One stage may output a plurality of gate signals, so that an area of the gate driver may be reduced.

### SUMMARY

Embodiments provide a gate driver having a reduced area.

Embodiments provide a display device having a reduced dead space.

In an embodiment, in a gate driver including a plurality of stages, each of the plurality of stages may include a common circuit which controls a voltage of a first control node, a voltage of a second control node, and a voltage of an inverted control node and an individual circuit which outputs a plurality of scan signals in response to the voltage of the first control node and the voltage of the inverted control node. The individual circuit may include a plurality of scan buffer transistors which output a plurality of scan clock signals as the plurality of scan signals in response to the voltage of the first control node and a scan hold transistor which maintains the plurality of scan signals at a first low voltage in response to the voltage of the inverted control node.

In an embodiment, the plurality of scan buffer transistors may include a first scan buffer transistor including a gate electrode connected to the first control node, a first electrode which receives a first scan clock signal, and a second electrode connected to a first scan output node which outputs a first scan signal output, a second scan buffer transistor including a gate electrode connected to the first control node, a first electrode which receives a second scan clock signal, and a second electrode connected to a second scan output node which outputs a second scan signal output, a third scan buffer transistor including a gate electrode connected to the first control node, a first electrode which receives a third scan clock signal, and a second electrode connected to a third scan output node which outputs a third scan signal output, and a fourth scan buffer transistor including a gate electrode connected to the first control node, a first electrode which receives a fourth scan clock signal, and a second electrode connected to a fourth scan output node which outputs a fourth scan signal output. The scan hold transistor may include a gate electrode connected to the inverted control node, a first electrode which receives the first low voltage, and a second electrode connected to the first to fourth scan output nodes.

In an embodiment, in a first period in which a voltage having a turn-on voltage level is applied to the first control node, first to fourth pulses corresponding to the first to fourth scan clock signals, respectively, may be sequentially output from the first to fourth scan output nodes, respectively.

In an embodiment, in a second period in which a voltage having a turn-on voltage level is applied to the inverted control node, the first low voltage may be output from the first to fourth output nodes.

In an embodiment, the individual circuit may further include a plurality of sensing buffer transistors which output a plurality of sensing clock signals as a plurality of sensing signals in response to the voltage of the first control node and a sensing hold transistor which maintains the plurality of sensing signals at the first low voltage in response to the voltage of the inverted control node.

In an embodiment, the plurality of sensing buffer transistors may include a first sensing buffer transistor including a gate electrode connected to the first control node, a first electrode which receives a first sensing clock signal, and a second electrode connected to a first sensing output node which outputs a first sensing signal output, a second sensing buffer transistor including a gate electrode connected to the first control node, a first electrode which receives a second sensing clock signal, and a second electrode connected to a second sensing output node which outputs a second sensing signal output, a third sensing buffer transistor including a gate electrode connected to the first control node, a first electrode which receives a third sensing clock signal, and a second electrode connected to a third sensing output node which outputs a third sensing signal output, and a fourth sensing buffer transistor including a gate electrode connected to the first control node, a first electrode which receives a fourth sensing clock signal, and a second electrode connected to a fourth sensing output node which outputs a fourth sensing signal output. The sensing hold transistor may include a gate electrode connected to the inverted control node, a first electrode which receives the first low voltage, and a second electrode connected to the first to fourth sensing output nodes.

In an embodiment, the common circuit may include a carry buffer transistor which outputs a carry clock signal as a carry signal in response to the voltage of the second control node and a carry hold transistor which maintains the carry signal at a second low voltage in response to the voltage of the inverted control node.

In an embodiment, the common circuit may further include a fourth transistor including a gate electrode that receives a previous carry signal, a first electrode that receives the previous carry signal, and a second electrode connected to the first control node and a 13^{th} transistor including a gate electrode that receives the previous carry signal, a first electrode that receives a high voltage, and a second electrode connected to the second control node.

In an embodiment, the fourth transistor may include sub-transistors connected in series with an intermediate node disposed in between. The common circuit may further include a 10^{th} transistor including a gate electrode connected to a carry output node from which the carry signal is output, a first electrode that receives the high voltage, and a second electrode connected to the intermediate node of the fourth transistor.

In an embodiment, the common circuit may further include an eighth transistor including a gate electrode that receives a next carry signal, a first electrode that receives the high voltage, and a second electrode connected to the inverted control node and a ninth transistor including a gate electrode that receives the next carry signal, a first electrode that receives the second low voltage, and a second electrode connected to the first control node.

In an embodiment, the common circuit may further include a seventh transistor including a gate electrode connected to the first control node, a first electrode that receives the second low voltage, and a second electrode connected to the inverted control node.

In an embodiment, the seventh transistor may include sub-transistors connected in series with an intermediate node disposed in between. The common circuit may further include a 12^{th} transistor including a gate electrode connected to the inverted control node, a first electrode that receives the high voltage, and a second electrode connected to the intermediate node of the seventh transistor.

In an embodiment, the common circuit may further include an 11^{th} transistor including a gate electrode connected to the inverted control node, a first electrode that receives the second low voltage, and a second electrode connected to the first control node and a 14^{th} transistor including a gate electrode connected to the inverted control node, a first electrode that receives the second low voltage, and a second electrode connected to the second control node.

In an embodiment, a display device may include a display panel including a plurality of pixels, a data driver which provides a plurality of data signals to the display panel, and a gate driver including a plurality of stages which provide a plurality of scan signals to the display panel. Each of the plurality of stages may include a common circuit which controls a voltage of a first control node, a voltage of a second control node, and a voltage of an inverted control node and an individual circuit which outputs the plurality of scan signals in response to the voltage of the first control node and the voltage of the inverted control node. The individual circuit may include a plurality of scan buffer transistors which output a plurality of scan clock signals as the plurality of scan signals in response to the voltage of the first control node and a scan hold transistor which maintains the plurality of scan signals at a first low voltage in response to the voltage of the inverted control node.

In an embodiment, the plurality of scan buffer transistors may include a first scan buffer transistor including a gate electrode connected to the first control node, a first electrode which receives a first scan clock signal, and a second electrode connected to a first scan output node which outputs a first scan signal output, a second scan buffer transistor including a gate electrode connected to the first control node, a first electrode which receives a second scan clock signal, and a second electrode connected to a second scan output node which outputs a second scan signal output, a third scan buffer transistor including a gate electrode connected to the first control node, a first electrode which receives a third scan clock signal, and a second electrode connected to a third scan output node which outputs a third scan signal output, and a fourth scan buffer transistor including a gate electrode connected to the first control node, a first electrode which receives a fourth scan clock signal, and a second electrode connected to a fourth scan output node which outputs a fourth scan signal output. The scan hold transistor may include a gate electrode connected to the inverted control node, a first electrode which receives the first low voltage, and a second electrode connected to the first to fourth scan output nodes.

In an embodiment, each of the plurality of pixels may include a first pixel transistor including a gate electrode connected to a first pixel node, a first electrode which receives a first power voltage, and a second electrode connected to a second pixel node, a second pixel transistor including a gate electrode which receives a scan signal of the plurality of scan signals, a first electrode which receives a data signal of the plurality of data signals, and a second electrode connected to the first pixel node, a third pixel transistor including a gate electrode, a first electrode which receives an initialization voltage, and a second electrode connected to the second pixel node, a storage capacitor including a first electrode connected to the first pixel node and a second electrode connected to the second pixel node, and a light emitting element including a first electrode connected to the second pixel node and a second electrode which receives a second power voltage.

In an embodiment, the gate electrode of the third pixel transistor receives the scan signal.

In an embodiment, the individual circuit may further include a plurality of sensing buffer transistors which output a plurality of sensing clock signals as a plurality of sensing signals in response to the voltage of the first control node and a sensing hold transistor which maintains the plurality of sensing signals at the first low voltage in response to the voltage of the inverted control node.

In an embodiment, the gate electrode of the third pixel transistor may receive a sensing signal of the plurality of sensing signals.

In an embodiment, the common circuit may include a carry buffer transistor which outputs a carry clock signal as a carry signal in response to the voltage of the second control node and a carry hold transistor which maintains the carry signal at a second low voltage in response to the voltage of the inverted control node.

In an embodiment, in the gate driver, the individual circuit of the stage may include one scan hold transistor which maintains the plurality of scan signals at the first low voltage, so that the area of the gate driver may be reduced.

The display device, according to an embodiment, may include the gate driver with the reduced area, so that the dead space of the display device may be reduced.

### BRIEF DESCRIPTION OF THE DRAWINGS

Illustrative, non-limiting embodiments will be more clearly understood from the following detailed description taken in conjunction with the accompanying drawings.

FIG. 1 is a schematic block diagram showing a display device, according to an embodiment.

FIG. 2 is a schematic block diagram showing an example of a gate driver included in the display device of FIG. 1, according to an embodiment.

FIG. 3 is a circuit diagram showing an example of a stage included in the gate driver of FIG. 2, according to an embodiment.

FIG. 4 is a timing diagram describing an operation of the stage of FIG. 3, according to an embodiment.

FIGS. 5 is a circuit diagram showing an example of a pixel included in the display device of FIG. 1, according to an embodiment.

FIG. 6 is a schematic block diagram showing an example of a gate driver included in the display device of FIG. 1, according to an embodiment.

FIG. 7 is a circuit diagram showing an example of a stage included in the gate driver of FIG. 6, according to an embodiment.

FIG. 8 is a circuit diagram showing an example of a pixel included in the display device of FIG. 1, according to an embodiment.

FIG. 9 is a block diagram showing an electronic apparatus, according to an embodiment.

FIG. 10 is a perspective view of an example in which the electronic apparatus of FIG. 9 is implemented as a computer monitor, according to an embodiment.

### DETAILED DESCRIPTION

Hereinafter, a gate driver and a display device according to embodiments will be described in more detail with reference to the accompanying drawings. The same or similar reference numerals will be used for the same elements in the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element (or a region, a layer, a portion, or the like) is referred to as being related to another such as being “on”, “connected to” or “coupled to” another element, it may be directly disposed on, connected or coupled to the other element, or intervening elements may be disposed therebetween.

Like reference numerals or symbols refer to like elements throughout. In the drawings, the thickness, the ratio, and the size of the element are exaggerated for effective description of the technical contents. As used herein, the term “and/or” includes any and all combinations of one or more of the associated listed items. The term “and/or,” includes all combinations of one or more of which associated configurations may define.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the scope of the invention. Similarly, a second element, component, region, layer or section may be termed a first element, component, region, layer or section. As used herein, the singular forms, “a”, “an” and “the” are intended to include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

It will be further understood that the terms “comprise”, “includes” and/or “have”, when used in this specification, specify the presence of stated features, integers, steps, operations, elements, components, and/or groups thereof, but do not preclude the presence or addition of one or more other features, integers, steps, operations, elements, components, and/or groups thereof. As used herein, being “disposed directly on” may mean that there is no additional layer, film, region, plate, or the like between a part and another part such as a layer, a film, a region, a plate, or the like. For example, being “disposed directly on” may mean that two layers or two members are disposed without using an additional member such as an adhesive member, therebetween.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

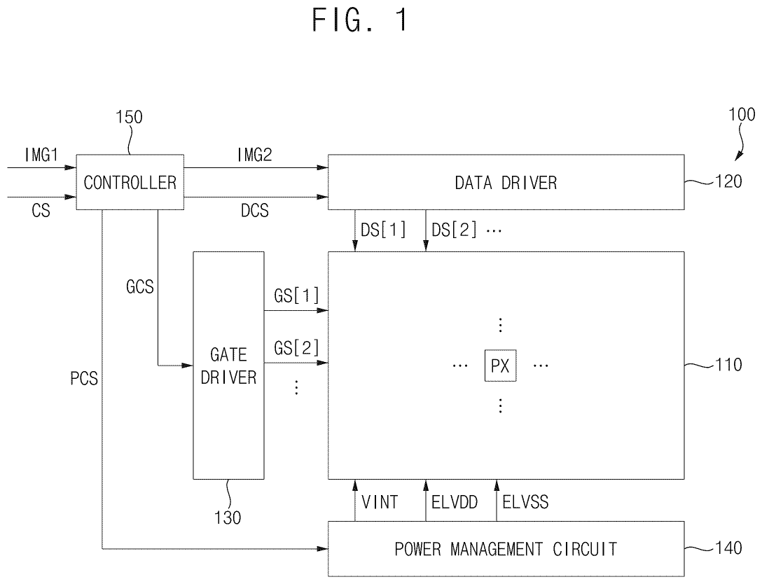

FIG. 1 is a schematic block diagram showing a display device 100, according to an embodiment.

In an embodiment and referring to FIG. 1, a display device 100 may include a display panel 110, a data driver 120, a gate driver 130, a power management circuit 140, and a controller 150.

In an embodiment, the display panel 110 may include a plurality of pixels PX. The pixels PX may receive a plurality of data signals DS[1], DS[2], . . . , a plurality of gate signals GS[1], GS[2], . . . , an initialization voltage VINT, a first power voltage ELVDD, and a second power voltage ELVSS.

In an embodiment, the data driver 120 may provide the data signals DS[1], DS[2], . . . to the display panel 110. The data driver 120 may generate the data signals DS[1], DS[2], . . . based on second image data IMG2 and a data control signal DCS. The second image data IMG2 may include grayscale values corresponding to the pixels PX.

In an embodiment, the gate driver 130 may provide the gate signals GS[1], GS[2], . . . to the display panel 110. The gate driver 130 may generate the gate signals GS[1], GS[2], . . . based on a gate control signal GCS.

In an embodiment, the power management circuit 140 may provide the initialization voltage VINT, the first power voltage ELVDD, and the second power voltage ELVSS to the display panel 110. The power management circuit 140 may generate the initialization voltage VINT, the first power voltage ELVDD, and the second power voltage ELVSS based on a power control signal PCS.

In an embodiment, the controller 150 may control an operation (or driving) of the data driver 120, an operation (or driving) of the gate driver 130, and an operation (or driving) of the power management circuit 140. The controller 150 may generate the second image data IMG2, the data control signal DCS, the gate control signal GCS, and power control signal PCS based on first image data IMG1 and a control signal CS. The first image data IMG1 may include grayscale values corresponding to the pixels PX.

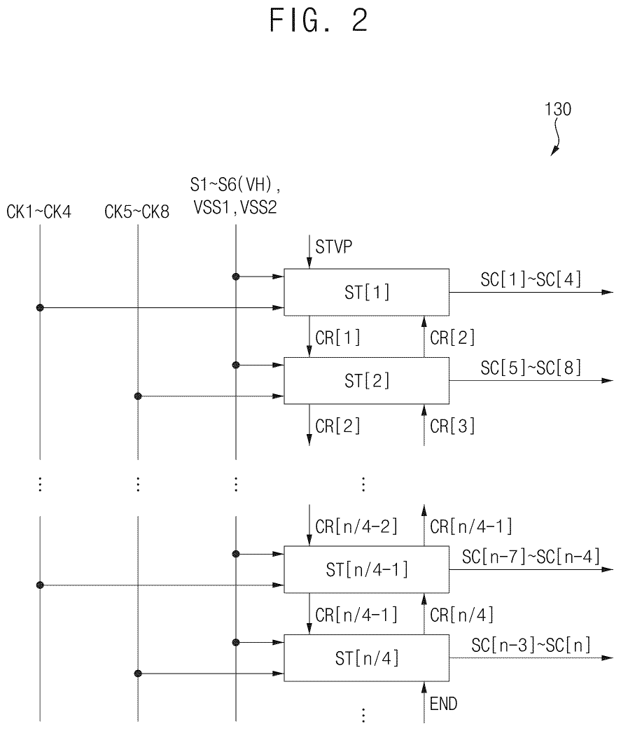

FIG. 2 is a schematic block diagram showing an example of a gate driver 130 included in the display device 100 of FIG. 1, according to an embodiment.

In an embodiment and referring to FIGS. 1 and 2, the gate driver 130 may include a plurality of stages ST[1], ST[2], . . . , ST[n/4-1], ST[n/4] (n is a multiple of 8 that is 16 or more).

In an embodiment, the stages ST[1], ST[2], . . . , ST[n/4-1], ST[n/4] may receive first to eighth clock signals CK1 to CK8, respectively, first to sixth input signals S1 to S6, respectively, a first low voltage VSS1, a second low voltage VSS2, and a gate start signal STVP. In an embodiment, the stages ST[1], ST[2], . . . , ST[n/4-1], ST[n/4] may output first to nth scan signals SC[1] to SC[n]. In this case, the gate signals GS[1], GS[2], . . . may include the first to nth scan signals SC[1] to SC[n], respectively.

In an embodiment, each of the stages ST[1], ST[2], . . . , ST[n/4-1], ST[n/4] may output a plurality of scan signals. In an embodiment, each of the stages ST[1], ST[2], . . . , ST[n/4-1], ST[n/4] may output four scan signals. For example, the first stage ST[1] may output the first to fourth scan signals SC[1] to SC[4], respectively, the second stage ST[2] may output the fifth to eighth scan signals SC[5] to SC[8], respectively, the n/4-1^{th} stage ST[n/4-1] may output the n-7^{th} to n-4^{th} scan signals SC[n-7] to SC[n-4], respectively, and the n/4^{th} stage ST[n/4] may outputs n-3^{th} to n^{th} scan signals SC[n-3] to SC[n], respectively.

In an embodiment, odd-numbered stages ST[1], . . . , ST[n/4-1] may receive the first to fourth clock signals CK1 to CK4, respectively, and the even-numbered stages ST[2], . . . , ST[n/4] may receive the fifth to eighth clock signals CK5 to CK8, respectively.

In an embodiment, the first stage ST[1] may receive the gate start signal STVP, and each the second to n/4^{th} stages ST[2], . . . , ST[n/4-1], ST[n/4], respectively, may receive a previous carry signal CR[1], . . . , CR[n/4-2], CR[n/4-1]. Each of the first to n/4-1^{th} stages ST[1], ST[2], . . . , ST[n/4-1], respectively, may receive a subsequent carry signals (CR[2], CR[3], . . . , CR[n/4], respectively), and the n/4^{th} stage ST[n/4] may receive a gate end signal END. Each of the first to n/4^{th} stages ST[1], ST[2], . . . , ST[n/4-1], ST[n/4], respectively, may output a carry signal CR[1], CR[2], . . . , CR[n/4-1], CR[n/4], respectively.

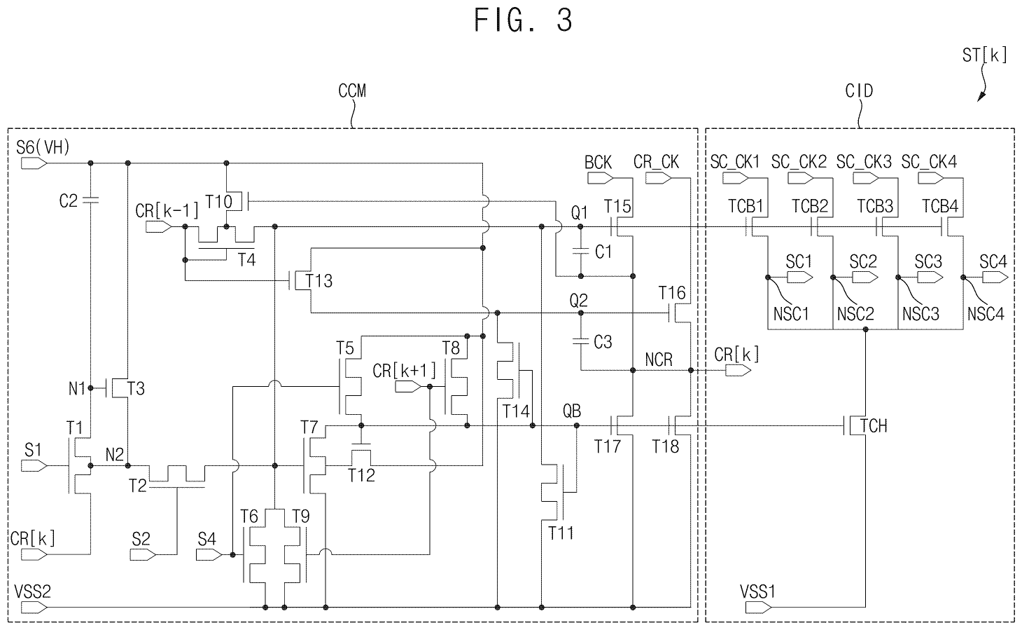

FIG. 3 is a circuit diagram showing an example of an embodiment, of a stage ST[k] (k is a natural number greater than or equal to 1 and less than or equal to n/4) included in the gate driver 130 of FIG. 2.

In an embodiment and referring to FIGS. 2 and 3, the stage ST[k] may include a common circuit CCM and an individual circuit CID. The common circuit CCM may control a voltage of a first control node Q1, a voltage of a second control node Q2, and a voltage of an inverting control node QB, and output a carry signal CR[k] in response to the voltage of the second control node Q2 and the voltage of the inverting control node QB. The individual circuit CID may output a plurality of scan signals SC1, SC2, SC3, and SC4 in response to the voltage of the first control node Q1 and the voltage of the inverting control node QB.

In an embodiment, when the stage ST[k] of FIG. 3 is the first stage ST[1] of FIG. 2, the scan signals SC1, SC2, SC3, and SC4 may be the first to fourth scan signals SC[1] to SC[4], respectively. When the stage ST[k] of FIG. 3 is the second stage ST[2] of FIG. 2, the scan signals SC1, SC2, SC3, and SC4 may be the fifth to eighth scan signals SC[5] to SC[8], respectively. When the stage ST[k] of FIG. 3 is the n/4-1^{th} stage ST[n/4-1] of FIG. 2, the scan signals SC1, SC2, SC3, and SC4 may be n-7^{th} to n-4^{th} scan signals SC[n-7] to SC[n-4], respectively. When the stage ST[k] of FIG. 3 is the n/4^{th} stage ST[n/4] of FIG. 2, the scan signals SC1, SC2, SC3, and SC4 may be the n-3^{th} to nth scan signals SC[n-3] to SC[n], respectively.

In an embodiment, when the stage ST[k] of FIG. 3 is one of the odd-numbered stages ST[1], . . . , ST[n/4-1] of FIG. 2, scan clock signals SC_CK1, SC_CK2, SC_CK3, and SC_CK4 may be the first clock signal CK1, second clock signal CK2, third clock signal CK3 and fourth clock signal CK4, respectively. When the stage ST[k] of FIG. 3 is one of the even-numbered stages ST[2], . . . , ST[n/4] of FIG. 2, the scan clock signals SC_CK1, SC_CK2, SC_CK3, and SC_CK4 may be the fifth clock signal CK5, sixth clock signal CK6, seventh clock signal CK7 and eighth clock signal CK8, respectively.

In an embodiment, the common circuit CCM may include a first transistor T1, a second transistor T2, a third transistor T3, a fourth transistor T4, a fifth transistor T5, a sixth transistor T6, a seventh transistor T7, an eighth transistor T8, ninth transistor T9, 10^{th} transistor T10, an 11^{th} transistor T11, a 12^{th} transistor T12, a 13^{th} transistor T13, a 14^{th} transistor T14, a 15^{th} transistor T15, a 16^{th} transistor T16, a 17^{th} transistor T17, a 18^{th} transistor T18, a first capacitor C1, a second capacitor C2, and a third capacitor C3.

In an embodiment, the first transistor T1 may include a gate electrode that receives a first input signal S1, a first electrode that receives the carry signal CR[k], and a second electrode connected to a first node N1. In an embodiment, the first transistor T1 may include sub-transistors connected in series with an intermediate node interposed therebetween. The intermediate node of the first transistor T1 may be connected to a second node N2.

In an embodiment, the second transistor T2 may include a gate electrode that receives a second input signal S2, a first electrode connected to the second node N2, and a second electrode connected to the first control node Q1. In an embodiment, the second transistor T2 may include sub-transistors connected in series with an intermediate node interposed therebetween.

In an embodiment, the third transistor T3 may include a gate electrode connected to the first node N1, a first electrode that receives a sixth input signal S6, and a second electrode connected to the second node N2. The sixth input signal S6 may be a high voltage VH having a turn-on voltage level of a transistor.

In an embodiment, the fourth transistor T4 may include a gate electrode that receives a previous carry signal CR[k-1], a first electrode that receives the previous carry signal CR[k-1], and a second electrode connected to the first control node Q1. In an embodiment, the fourth transistor T4 may include sub-transistors connected in series with an intermediate node interposed therebetween.

In an embodiment, the fifth transistor T5 may include a gate electrode that receives a fourth input signal S4, a first electrode that receives the high voltage VH, and a second electrode connected to the inverting control node QB. In an embodiment, the fifth transistor T5 may include sub-transistors connected in series with an intermediate node interposed therebetween.

In an embodiment, the sixth transistor T6 may include a gate electrode that receives the fourth input signal S4, a first electrode that receives the second low voltage VSS2, and a second electrode connected to the first control node Q1. The second low voltage VSS2 may have a turn-off voltage level of the transistor. In an embodiment, the sixth transistor T6 may include sub-transistors connected in series with an intermediate node interposed therebetween.

In an embodiment, the seventh transistor T7 may include a gate electrode connected to the first control node Q1, a first electrode that receives the second low voltage VSS2, and a second electrode connected to the inverting control node QB. In an embodiment, the seventh transistor T7 may include sub-transistors connected in series with an intermediate node interposed therebetween.

In an embodiment, the eighth transistor T8 may include a gate electrode that receives the subsequent carry signal CR[k+1], a first electrode that receives the high voltage VH, and a second electrode connected to the inverting control node QB. In an embodiment, the eighth transistor T8 may include sub-transistors connected in series with an intermediate node interposed therebetween.

In an embodiment, the ninth transistor T9 may include a gate electrode that receives the subsequent carry signal CR[k+1], a first electrode that receives the second low voltage VSS2, and a second electrode connected to the first control node Q1. In an embodiment, the ninth transistor T9 may include sub-transistors connected in series with an intermediate node interposed therebetween.

In an embodiment, the 10^{th} transistor T10 may include a gate electrode connected to a carry output node NCR from which the carry signal CR[k] is output, a first electrode that receives the high voltage VH, and a second electrode connected to the intermediate node of the fourth transistor T4.

In an embodiment, the 11^{th} transistor T11 may include a gate electrode connected to the inverting control node QB, a first electrode that receives the second low voltage VSS2, and a second electrode connected to the first control node Q1. In an embodiment, the 11^{th} transistor T11 may include sub-transistors connected in series with an intermediate node interposed therebetween.

In an embodiment, the 12^{th} transistor T12 may include a gate electrode connected to the inverting control node QB, a first electrode that receives the high voltage VH, and a second electrode connected to the intermediate node of the seventh transistor T7.

In an embodiment, the 13^{th} transistor T13 may include a gate electrode that receives the previous carry signal CR[k-1], a first electrode that receives the high voltage VH, and a second electrode connected to the second control node Q2.

In an embodiment, the 14^{th} transistor T14 may include a gate electrode connected to the inverting control node QB, a first electrode that receives the second low voltage VSS2, and a second electrode connected to the second control node Q2. In an embodiment, the 14^{th} transistor T14 may include sub-transistors connected in series with an intermediate node interposed therebetween.

In an embodiment, the 15^{th} transistor T15 may include a gate electrode connected to the first control node Q1, a first electrode that receives a boosting clock signal BCK, and a second electrode connected to the carry output node NCR.

In an embodiment, the 16^{th} transistor T16 may output a carry clock signal CR_CK as the carry signal CR[k] in response to the voltage of the second control node Q2. The sixteenth transistor T16 may include a gate electrode connected to the second control node Q2, a first electrode that receives the carry clock signal CR_CK, and a second electrode connected to the carry output node NCR. The 16^{th} transistor T16 may be referred as a carry buffer transistor.

In an embodiment, the 17^{th} transistor T17 may maintain the carry signal CR[k] at the second low voltage VSS2 in response to the voltage of the inverting control node QB. The 17^{th} transistor T17 may include a gate electrode connected to the inverting control node QB, a first electrode that receives the second low voltage VSS2, and a second electrode connected to the carry output node NCR.

In an embodiment, the 18^{th} transistor T18 may maintain the carry signal CR[k] at the second low voltage VSS2 in response to the voltage of the inverting control node QB. The 18^{th} transistor T18 may include a gate electrode connected to the inverting control node QB, a first electrode that receives the second low voltage VSS2, and a second electrode connected to the carry output node NCR. The 17^{th} transistor T17 and the 18^{th} transistor T18 may be referred as a carry hold transistor.

In an embodiment, the first capacitor C1 may include a first electrode connected to the carry output node NCR and a second electrode connected to the first control node Q1.

In an embodiment, the second capacitor C2 may include a first electrode that receives the high voltage VH and a second electrode connected to the first node N1.

In an embodiment, the third capacitor C3 may include a first electrode connected to the carry output node NCR and a second electrode connected to the second control node Q2.

In an embodiment, the individual circuit CID may include a plurality of scan buffer transistors TCB1, TCB2, TCB3, and TCB4 and a scan hold transistor TCH.

In an embodiment, the scan buffer transistors TCB1, TCB2, TCB3, and TCB4 may output a plurality of scan clock signals SC_CK1, SC_CK2, SC_CK3, and SC_CK4, respectively, as the plurality of scan signals SC1, SC2, SC3, and SC4, respectively, in response to the voltage of the first control node Q1. The scan buffer transistors TCB1, TCB2, TCB3, and TCB4 may include a first scan buffer transistor TCB1, a second scan buffer transistor TCB2, a third scan buffer transistor TCB3, and a fourth scan buffer transistor TCB4.

In an embodiment, the first scan buffer transistor TCB 1 may include a gate electrode connected to the first control node Q1, a first electrode that receives the first scan clock signal SC_CK1, and a second electrode connected to a first scan output node NSC1 from which the first scan signal SC1 is output.

In an embodiment, the second scan buffer transistor TCB2 may include a gate electrode connected to the first control node Q1, a first electrode that receives the second scan clock signal SC_CK2, and a second electrode connected to a second scan output node NSC2 from which the second scan signal SC2 is output.

In an embodiment, the third scan buffer transistor TCB3 may include a gate electrode connected to the first control node Q1, a first electrode that receives the third scan clock signal SC_CK3, and a second electrode connected to a third scan output node NSC3 from which the third scan signal SC3 is output.

In an embodiment, the fourth scan buffer transistor TCB4 may include a gate electrode connected to the first control node Q1, a first electrode that receives the fourth scan clock signal SC_CK4, and a second electrode connected to a fourth scan output node NSC4 from which the fourth scan signal SC4 is output.

In an embodiment, the scan hold transistor TCH may maintain the plurality of scan signals SC1, SC2, SC3, and SC4 at the first low voltage VSS1 in response to the voltage of the inverting control node QB. The first low voltage VSS1 may have a turn-off voltage level of the transistor. The scan hold transistor TCH may include a gate electrode connected to the inverting control node QB, a first electrode that receives the first low voltage VSS1, and a second electrode connected to the first to fourth scan output nodes NSC1, NSC2, NSC3, and NSC4, respectively.

In an embodiment, each of the transistors T1, T2, T3, T4, T5, T6, T7, T8, T9, T10, T11, T12, T13, T14, T15, T16, T17, T18, TCB1, TCB2, TCB3, TCB4, and TCH included in the stage ST[k] may be an N-type transistor (e.g., NMOS transistor). However, the invention is not limited thereto, and in another embodiment, at least one of the transistors T1, T2, T3, T4, T5, T6, T7, T8, T9, T10, T11, T12, T13, T14, T15, T16, T17, T18, TCB1, TCB2, TCB3, TCB4, and TCH may be a P-type transistor (e.g., PMOS transistor).

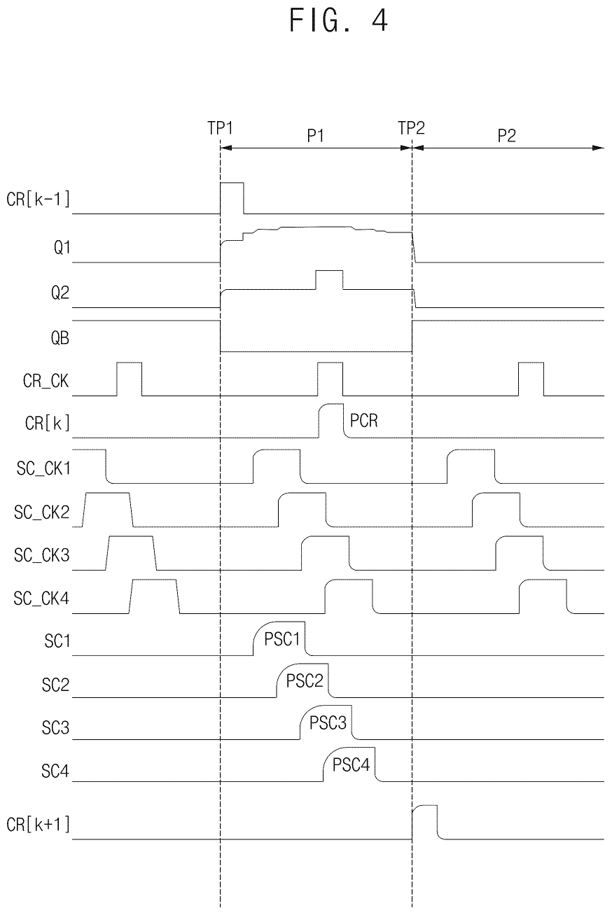

FIG. 4 is a view for describing an operation of the stage ST[k] of FIG. 3, according to an embodiment.

In an embodiment and referring to FIGS. 3 and 4, at a first time point TP1, the previous carry signal CR[k-1] may transition from the turn-off voltage level (low voltage level) to the turn-on voltage level (high voltage level). The fourth transistor T4 may transmit a voltage having the turn-on voltage level of the previous carry signal CR[k-1] to the first control node Q1 in response to the previous carry signal CR[k-1] having the turn-on voltage level. The 13^{th} transistor T13 may transmit the high voltage VH to the second control node Q2 in response to the previous carry signal CR[k-1] having the turn-on voltage level. The seventh transistor T7 may transmit the second low voltage VSS2 to the inverting control node QB in response to the voltage of the first control node Q1 having the turn-on voltage level.

In an embodiment, in a first period P1 in which a voltage having the turn-on voltage level is applied to each of the first control node Q1 and the second control node Q2 and a voltage having the turn-off voltage level is applied to the inverting control node QB, first pulse PSC1, second pulse PSC2, third pulse PSC3 and fourth pulse PSC4 of the first to fourth scan signals SC1, SC2, SC3, and SC4, respectively, corresponding to the first scan clock signal SC_CK1, second scan clock signal SC_CK2, third scan clock signal SC_CK3, and fourth scan clock signal SC_CK4, respectively, may be sequentially output from the first to fourth scan output nodes NSC1, NSC2, NSC3, and NSC4, respectively. In the first period P1, the first scan buffer transistor TCB1, second scan buffer transistor TCB2, third scan buffer transistor TCB3 and fourth scan buffer transistor TCB4 may output the first to fourth scan clock signals SC_CK1, SC_CK2, SC_CK3, respectfully, and SC_CK4 as the first to fourth scan signals SC1, SC2, SC3, and SC4, respectively, in response to a voltage having the turn-on voltage level of the first control node Q1.

In an embodiment, in the first period P1, a pulse PCR of the carry signal CR[k] corresponding to the carry clock signal CR_CK may be output from the carry output node NCR. In the first period P1, the 16^{th} transistor T16 may output the carry clock signal CR_CK as the carry signal CR[k] in response to a voltage of the turn-on voltage level of the second control node Q2.

In an embodiment, at a second time point TP2, the subsequent carry signal CR[K+1] may transition from the turn-off voltage level to the turn-on voltage level. The eighth transistor T8 may transmit the high voltage VH to the inverting control node QB in response to the subsequent carry signal CR[K+1] having the turn-on voltage level. The ninth transistor T9 may transmit the second low voltage VSS2 to the first control node Q1 in response to the subsequent carry signal CR[K+1] having the turn-on voltage level. The 14^{th} transistor T14 may transmit the second low voltage VSS2 to the second control node Q2 in response to the voltage of the inverting control node QB having the turn-on voltage level.

In an embodiment, in a second period P2 in which a voltage having the turn-off voltage level is applied to each of the first control node Q1 and the second control node Q2 and a voltage having the turn-on voltage level is applied to the inverting control node QB, the first low voltage VSS1 may be output from the first to fourth scan output nodes NSC1, NSC2, NSC3, and NSC4, respectively. In the second period P2, the scan hold transistor TCH may output the first low voltage VSS1 as the first to fourth scan signals SC1, SC2, SC3, and SC4, respectively, in response to a voltage having the turn-on voltage level of the inverting control node QB.

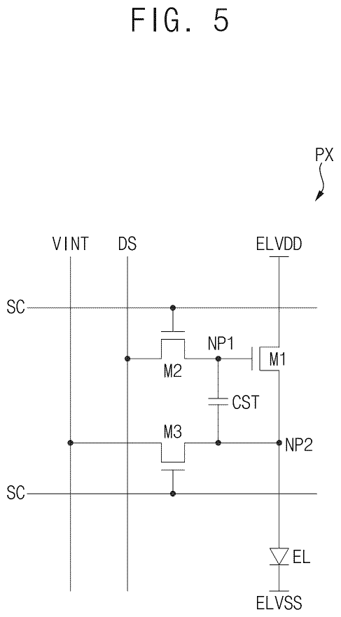

FIGS. 5 is a circuit diagram showing an example of a pixel PX included in the display device 100 of FIG. 1, according to an embodiment.

In an embodiment and referring to FIG. 5, the pixel PX may include a first pixel transistor M1, a second pixel transistor M2, a third pixel transistor M3, a storage capacitor CST, and a light emitting element EL.

In an embodiment, the first pixel transistor MI may include a gate electrode connected to a first pixel node NP1, a first electrode that receives the first power voltage ELVDD, and a second electrode connected to a second pixel node NP2.

In an embodiment, the second pixel transistor M2 may include a gate electrode that receives the scan signal SC, a first electrode that receives the data signal DS, and a second electrode connected to the first pixel node NP1.

In an embodiment, the third pixel transistor M3 may include a gate electrode that receives the scan signal SC, a first electrode that receives the initialization voltage VINT, and a second electrode connected to the second pixel node NP2.

In an embodiment, each of the transistors M1, M2, and M3 included in the pixel PX may be an N-type transistor. However, the invention is not limited thereto, and in another embodiment, at least one of the transistors M1, M2, and M3 included in the pixel PX may be a P-type transistor.

In an embodiment, the storage capacitor CST may include a first electrode connected to the first pixel node NP1 and a second electrode connected to the second pixel node NP2.

In an embodiment, the pixel PX may include three transistors and one capacitor. However, the invention is not limited thereto, and in another embodiment, the pixel PX may include 2 or 4 transistors and/or 2 or more capacitors.

In an embodiment, the light emitting element EL may include a first electrode connected to the second pixel node NP2 and a second electrode that receives the second power voltage ELVSS. In an embodiment, the light emitting element EL may be an organic light emitting diode. However, the invention is not limited thereto, and in another embodiment, the light emitting element EL may be one of an inorganic light emitting diode, a micro light emitting diode, and a quantum dot light emitting diode.

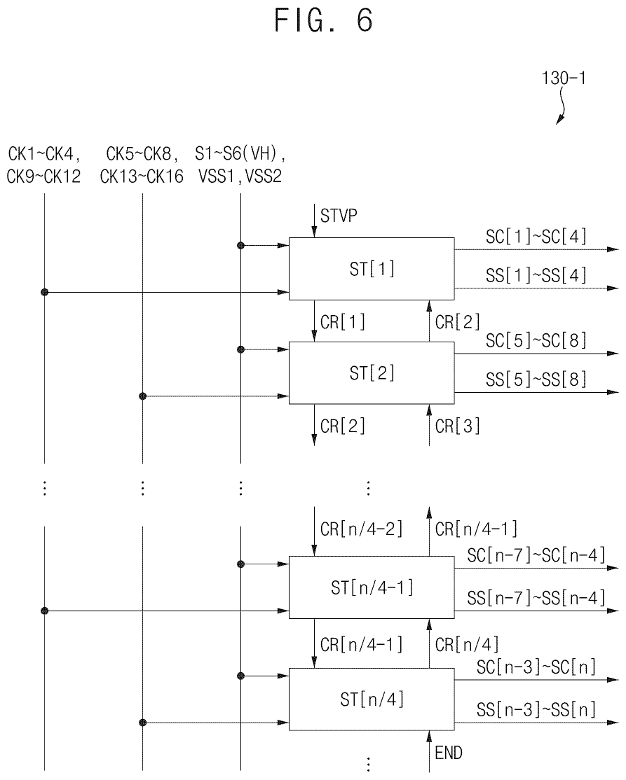

FIG. 6 is a block diagram showing an example of a gate driver 130-1 included in the display device 100 of FIG. 1, according to an embodiment.

In an embodiment and referring to FIGS. 1 and 6, a gate driver 130-1 may include a plurality of stages ST[1], ST[2], . . . , ST[n/4-1], ST[n/4]. Descriptions of elements of the gate driver 130-1 described with reference to FIG. 6, which are substantially the same as or similar to those of the gate driver 130 described with reference to FIG. 2, will be omitted.

In an embodiment, the stages ST[1], ST[2], . . . , ST[n/4-1], ST[n/4] may include first to sixteenth clock signals CK1 to CK16, respectively, first to sixth input signals S1 to S6, respectively, a first low voltage VSS1, a second low voltage VSS2, and a gate start signal STVP. In an embodiment, the stages ST[1], ST[2], . . . , ST[n/4-1], ST[n/4] may output first to nth scan signals SC[1] to SC[n], respectively, and first to nth sensing signals SS[1] to SS[n], respectively. In this case, the gate signals GS[1], GS[2], . . . may include the first to nth scan signals SC[1] to SC[n], respectively, and the first to nth sensing signals SS[1] to SS[n], respectively.

In an embodiment, each of the stages ST[1], ST[2], . . . , ST[n/4-1], ST[n/4] may output a plurality of scan signals and a plurality of sensing signals. In an embodiment, each of the stages ST[1], ST[2], . . . , ST[n/4-1], ST[n/4] may output 4 scan signals and 4 sensing signals. For example, the first stage ST[1] may output the first to fourth scan signals SC[1] to SC[4], respectively, and the first to fourth sensing signals SS[1] to SS[4], respectively, the second stage ST[2] may output the fifth to eighth scan signals SC[5] to SC[8], respectively, and the fifth to eighth sensing signals SS[5] to SS[8], respectively, the n/4-1^{th} stage ST[n/4-1] may output the n-7^{th} to n-4^{th} scan signals SC[n-7] to SC[n-4], respectively, and the n-7^{th} to n-4^{th} sensing signals SS[n-7] to SS[n-4], respectively, and the n/4th stage ST[n/4] may output the n-3^{th} to nth scan signals SC[n-3] to SC[n], respectively, and the n-3^{th} to n^{th} sensing signals SS[n-3] to SS[n], respectively.

In an embodiment, odd-numbered stages ST[1], . . . , ST[n/4-1] may receive the first to fourth clock signals CK1 to CK4, respectively, and the ninth to 12^{th} clock signals CK9 to CK12, respectively, and the even-numbered stages ST[2], . . . , ST[n/4] may receive the fifth to eighth clock signals CK5 to CK8, respectively and the 13^{th} to 16^{th} clock signals CK13 to CK16, respectively.

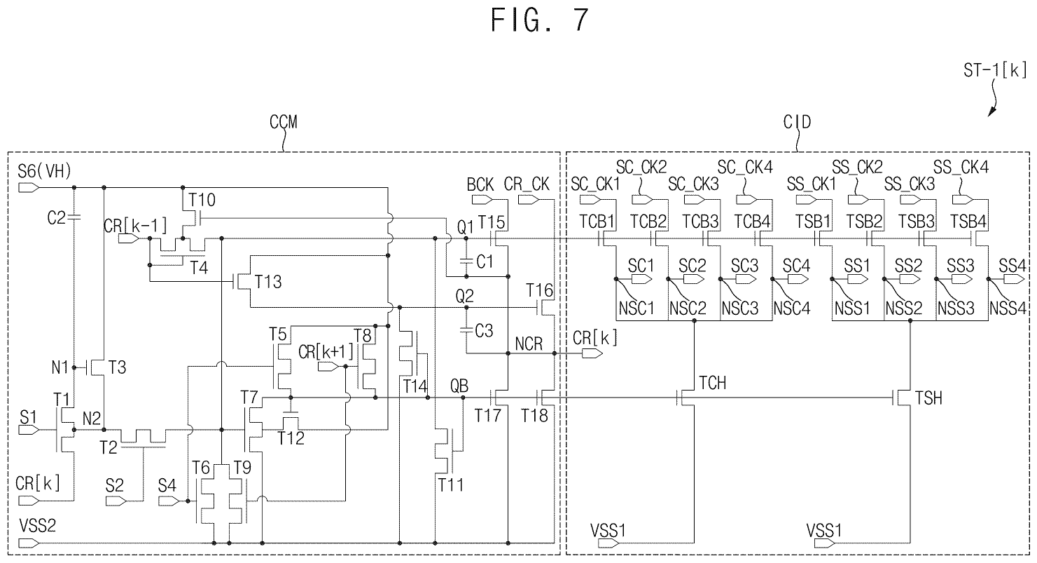

FIG. 7 is a circuit diagram showing an example of a stage ST-1[k] included in the gate driver 130-1 of FIG. 6, according to an embodiment.

In an embodiment and referring to FIGS. 6 and 7, a stage ST-1[k] may include a common circuit CCM and an individual circuit CID. The common circuit CCM may control a voltage of a first control node Q1, a voltage of a second control node Q2, and a voltage of an inverting control node QB, and output a carry signal CR[k] in response to the voltage of the second control node Q2 and the voltage of the inverting control node QB. The individual circuit CID may output a plurality of scan signals SC1, SC2, SC3, and SC4 and a plurality of sensing signals SS1, SS2, SS3, and SS4 in response to the voltage of the first control node Q1 and the voltage of the inverting control node QB. Descriptions of elements of the stage ST-1[k] described with reference to FIG. 7, which are substantially the same as or similar to the stage ST[k] described with reference to FIG. 3, will be omitted.

In an embodiment, when the stage ST-1[k] of FIG. 7 is the first stage ST[1] of FIG. 6, the sensing signals SS1, SS2, SS3, and SS4 may be the first to fourth sensing signals SS[1] to SS[4], respectively. When the stage ST-1[k] of FIG. 7 is the second stage ST[2] of FIG. 6, the sensing signals SS1, SS2, SS3, and SS4 may be the fifth to eighth sensing signals SS[5] to SS[8], respectively. When the stage ST-1[k] of FIG. 7 is the n/4-1^{th} stage ST[n/4-1] of FIG. 6, the sensing signals SS1, SS2, SS3, and SS4 may be n-7^{th} to n-4^{th} sensing signals SS[n-7] to SS[n-4], respectively. When the stage ST-1[k] of FIG. 7 is the n/4^{th} stage ST[n/4] of FIG. 6, the sensing signals SS1, SS2, SS3, and SS4 may be the n-3^{th} to n^{th} sensing signals SS[n-3] to SS[n], respectively.

In an embodiment, when the stage ST-1[k] of FIG. 7 is one of the odd-numbered stages ST[1], . . . , ST[n/4-1] of FIG. 6, sensing clock signals SS_CK1, SS_CK2, SS_CK3, and SS_CK4 may be the ninth to twelfth clock signals CK9 to CK12, respectively. When the stage ST-1[k] of FIG. 7 is one of the even-numbered stages ST[2], . . . , ST[n/4] of FIG. 6, the sensing clock signals SS_CK1, SS_CK2, SS_CK3, and SS_CK4 may be the thirteenth to sixteenth clock signals CK13 to CK16, respectively.

In an embodiment, the individual circuit CID may include a plurality of scan buffer transistors TCB1, TCB2, TCB3, and TCB4, a scan hold transistor TCH, a plurality of sensing buffer transistors TSB1, TSB2, TSB3, and TSB4, and a sensing hold transistor TSH.

In an embodiment, the sensing buffer transistors TSB1, TSB2, TSB3, and TSB4 may output a plurality of sensing clock signals SS_CK1, SS_CK2, SS_CK3, and SS_CK4, respectfully, as the plurality of sensing signals SS1, SS2, SS3, and SS4, respectively, in response to to the voltage of the first control node Q1. The sensing buffer transistors TSB1, TSB2, TSB3, and TSB4 may include a first sensing buffer transistor TSB1, a second sensing buffer transistor TSB2, a third sensing buffer transistor TSB3, and a fourth sensing buffer transistor TSB4.

In an embodiment, the first sensing buffer transistor TSB1 may include a gate electrode connected to the first control node Q1, a first electrode that receives the first sensing clock signal SS_CK1, and a second electrode connected to a first sensing output node NSS1 from which the first sensing signal SS1 is output.

In an embodiment, the second sensing buffer transistor TSB2 may include a gate electrode connected to the first control node Q1, a first electrode that receives the second sensing clock signal SS_CK2, and a second electrode connected to a second sensing output node NSS2 from which the second sensing signal SS2 is output.

In an embodiment, the third sensing buffer transistor TSB3 may include a gate electrode connected to the first control node Q1, a first electrode that receives the third sensing clock signal SS_CK3, and a second electrode connected to a third sensing output node NSS3 from which the third sensing signal SS3 is output.

In an embodiment, the fourth sensing buffer transistor TSB4 may include a gate electrode connected to the first control node Q1, a first electrode that receives the fourth sensing clock signal SS_CK4, and a second electrode connected to a fourth sensing output node NSS4 from which the fourth sensing signal SS4 is output.

In an embodiment, the sensing hold transistor TSH may maintain the plurality of sensing signals SS1, SS2, SS3, and SS4 at the first low voltage VSS1 in response to the voltage of the inverting control node QB. The sensing hold transistor TSH may include a gate electrode connected to the inverting control node QB, a first electrode that receives the first low voltage VSS1, and a second electrode connected to the first to fourth sensing output nodes NSS1, NSS2, NSS3, and NSS4, respectively.

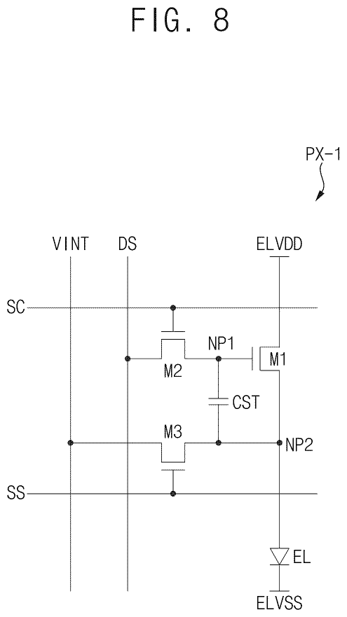

FIG. 8 is a circuit diagram showing an example of a pixel PX-1 included in the display device 100 of FIG. 1, according to an embodiment.

In an embodiment and referring to FIG. 8, a pixel PX-1 may include a first pixel transistor M1, a second pixel transistor M2, a third pixel transistor M3, a storage capacitor

CST, and a light emitting element EL. Descriptions of elements of the pixel PX-1 described with reference to FIG. 8, which are substantially the same as or similar to the pixel PX described with reference to FIG. 5, will be omitted.

In an embodiment, the third pixel transistor M3 may include a gate electrode that receives the sensing signal SS, a first electrode that receives the initialization voltage VINT, and a second electrode connected to the second pixel node NP2.

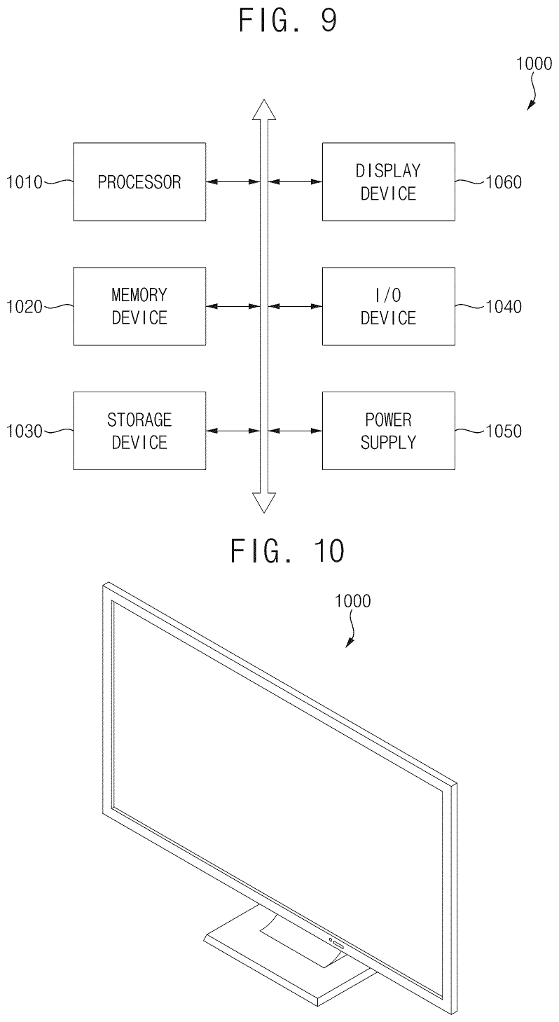

FIG. 9 is a block diagram showing an electronic apparatus 1000, according to an embodiment. FIG. 10 is a view showing an example of an embodiment in which the electronic apparatus 1000 of FIG. 9 is implemented as a computer monitor.

In an embodiment and referring to FIGS. 9 and 10, an electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with a video card, a sound card, a memory card, a USB device, and the like, or communicating with other systems.

In an embodiment, as shown in FIG. 10, the electronic apparatus 1000 may be implemented as a display device. However, the invention is not limited thereto, and according to another embodiment, the electronic apparatus 1000 may be implemented as a television, a mobile phone, a video phone, a smart pad, a tablet PC, a vehicle navigation, a laptop computer, a head-mounted display, or the like.

In an embodiment, the processor 1010 may perform specific calculations or tasks. According to an embodiment, the processor 1010 may be a microprocessor, a central processing unit (CPU), or the like. The processor 1010 may be connected to other components through an address bus, a control bus, a data bus, and the like. According to an embodiment, the processor 1010 may also be connected to an expansion bus such as a peripheral component interconnect (PCI) bus. In an embodiment, the processor 1010 may provide first image data (IMG1 of FIG. 1) and a control signal (CS of FIG. 1) to the display device 1060.

In an embodiment, the memory device 1020 may store data required for an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

In an embodiment, the storage device 1030 may include a solid state drive (SSD), a hard disk drive (HDD), a CD-ROM, and the like. The I/O device 1040 may include: an input device such as a keyboard, a keypad, a touch pad, a touch screen, or a mouse; and an output device such as a speaker or a printer. The power supply 1050 may supply a power required for the operation of the electronic apparatus 1000. The display device 1060 may be connected to other components through the buses or other communication links. The display device 1060 may correspond to the display device 100 of FIG. 1.

In an embodiment, in a gate driver included in the display device 1060, an individual circuit of a stage may include one scan hold transistor which maintains a plurality of scan signals at a first low voltage, so that an area of the gate driver may be reduced. Accordingly, a dead space of the display device 1060 may be reduced.

The display device, according to an embodiment, may be applied to a display device included in a computer, a notebook, a mobile phone, a smart phone, a smart pad, a smart watch, a PMP, a PDA, an MP3 player, or the like.

Although the gate drivers and the display devices, according to embodiments, have been described with reference to the drawings, the illustrated embodiments are examples, and may be modified and changed by a person having ordinary knowledge in the relevant technical field without departing from the technical spirit.

Although a few embodiments have been described, those skilled in the art will readily appreciate that many modifications are possible without materially departing from the novel teachings and advantages of the invention. Accordingly, all such modifications are intended to be included within the scope of the invention. Therefore, it is to be understood that the foregoing is illustrative of various embodiments and is not to be construed as limited to the specific embodiments disclosed, and that modifications to the disclosed embodiments, as well as other embodiments, are intended to be included within the scope of the invention. Moreover, the embodiments or parts of the embodiments may be combined in whole or in part without departing from the scope of the invention.

What is claimed is:

1. A gate driver including a plurality of stages, each of the plurality of stages comprising:
a common circuit which controls a voltage of a first control node, a voltage of a second control node, and a voltage of an inverted control node; and
an individual circuit which outputs a plurality of scan signals in response to the voltage of the first control node and the voltage of the inverted control node,
wherein the individual circuit includes:
a plurality of scan buffer transistors which output a plurality of scan clock signals as the plurality of scan signals in response to the voltage of the first control node; and
a scan hold transistor which maintains the plurality of scan signals at a first low voltage in response to the voltage of the inverted control node.

2. The gate driver of claim 1, wherein the plurality of scan buffer transistors include:
a first scan buffer transistor including a gate electrode connected to the first control node, a first electrode which receives a first scan clock signal, and a second electrode connected to a first scan output node which outputs a first scan signal;
a second scan buffer transistor including a gate electrode connected to the first control node, a first electrode which receives a second scan clock signal, and a second electrode connected to a second scan output node which outputs a second scan signal;
a third scan buffer transistor including a gate electrode connected to the first control node, a first electrode which receives a third scan clock signal, and a second electrode connected to a third scan output node which outputs a third scan signal; and
a fourth scan buffer transistor including a gate electrode connected to the first control node, a first electrode which receives a fourth scan clock signal, and a second electrode connected to a fourth scan output node which outputs a fourth scan signal, and
wherein the scan hold transistor includes a gate electrode connected to the inverted control node, a first electrode which receives the first low voltage, and a second electrode connected to the first to fourth scan output nodes.

3. The gate driver of claim 2, wherein, in a first period in which a voltage having a turn-on voltage level is applied to the first control node, first to fourth pulses corresponding to the first to fourth scan clock signals, respectively, are sequentially output from the first to fourth scan output nodes, respectively.

4. The gate driver of claim 3, wherein, in a second period in which a voltage having a turn-on voltage level is applied to the inverted control node, the first low voltage is output from the first to fourth output nodes.

5. The gate driver of claim 1, wherein the individual circuit further includes:
a plurality of sensing buffer transistors which output a plurality of sensing clock signals as a plurality of sensing signals in response to the voltage of the first control node; and
a sensing hold transistor which maintains the plurality of sensing signals at the first low voltage in response to the voltage of the inverted control node.

6. The gate driver of claim 5, wherein the plurality of sensing buffer transistors include:
a first sensing buffer transistor including a gate electrode connected to the first control node, a first electrode which receives a first sensing clock signal, and a second electrode connected to a first sensing output node which outputs a first sensing signal;
a second sensing buffer transistor including a gate electrode connected to the first control node, a first electrode which receives a second sensing clock signal, and a second electrode connected to a second sensing output node which outputs a second sensing signal output;
a third sensing buffer transistor including a gate electrode connected to the first control node, a first electrode which receives a third sensing clock signal, and a second electrode connected to a third sensing output node which outputs a third sensing signal output; and
a fourth sensing buffer transistor including a gate electrode connected to the first control node, a first electrode which receives a fourth sensing clock signal, and a second electrode connected to a fourth sensing output node which outputs a fourth sensing signal, and
wherein the sensing hold transistor includes a gate electrode connected to the inverted control node, a first electrode which receives the first low voltage, and a second electrode connected to the first to fourth sensing output nodes.

7. The gate driver of claim 1, wherein the common circuit includes:
a carry buffer transistor which outputs a carry clock signal as a carry signal in response to the voltage of the second control node; and
a carry hold transistor which maintains the carry signal at a second low voltage in response to the voltage of the inverted control node.

8. The gate driver of claim 7, wherein the common circuit further includes:
a fourth transistor including a gate electrode that receives a previous carry signal, a first electrode that receives the previous carry signal, and a second electrode connected to the first control node; and
a 13th transistor including a gate electrode that receives the previous carry signal, a first electrode that receives a high voltage, and a second electrode connected to the second control node.

9. The gate driver of claim 8, wherein the fourth transistor further includes sub-transistors connected in series with an intermediate node disposed in between, and
wherein the common circuit further includes:
a 10^{th} transistor including a gate electrode connected to a carry output node from which the carry signal is output, a first electrode that receives the high voltage, and a second electrode connected to the intermediate node of the fourth transistor.

10. The gate driver of claim 8, wherein the common circuit further includes:
an eighth transistor including a gate electrode that receives a next carry signal, a first electrode that receives the high voltage, and a second electrode connected to the inverted control node; and
a ninth transistor including a gate electrode that receives the next carry signal, a first electrode that receives the second low voltage, and a second electrode connected to the first control node.

11. The gate driver of claim 7, wherein the common circuit further includes:
a seventh transistor including a gate electrode connected to the first control node, a first electrode that receives the second low voltage, and a second electrode connected to the inverted control node.

12. The gate driver of claim 11, wherein the seventh transistor further includes sub-transistors connected in series with an intermediate node disposed in between, and
wherein the common circuit further includes:
a 12^{th} transistor including a gate electrode connected to the inverted control node, a first electrode that receives the high voltage, and a second electrode connected to the intermediate node of the seventh transistor.

13. The gate driver of claim 7, wherein the common circuit further includes:
an 11^{th} transistor including a gate electrode connected to the inverted control node, a first electrode that receives the second low voltage, and a second electrode connected to the first control node; and
a 14^{th} transistor including a gate electrode connected to the inverted control node, a first electrode that receives the second low voltage, and a second electrode connected to the second control node.

14. A display device, comprising:
a display panel including a plurality of pixels;
a data driver which provides a plurality of data signals to the display panel; and
a gate driver including a plurality of stages which provide a plurality of scan signals to the display panel,
wherein each of the plurality of stages includes:
a common circuit which controls a voltage of a first control node, a voltage of a second control node, and a voltage of an inverted control node; and
an individual circuit which outputs the plurality of scan signals in response to the voltage of the first control node and the voltage of the inverted control node, and
wherein the individual circuit includes:
a plurality of scan buffer transistors which output a plurality of scan clock signals as the plurality of scan signals in response to the voltage of the first control node; and
a scan hold transistor which maintains the plurality of scan signals at a first low voltage in response to the voltage of the inverted control node.

15. The display device of claim 14, wherein the plurality of scan buffer transistors include:
a first scan buffer transistor including a gate electrode connected to the first control node, a first electrode which receives a first scan clock signal, and a second electrode connected to a first scan output node which outputs a first scan signal;
a second scan buffer transistor including a gate electrode connected to the first control node, a first electrode which receives a second scan clock signal, and a second electrode connected to a second scan output node which outputs a second scan signal;
a third scan buffer transistor including a gate electrode connected to the first control node, a first electrode which receives a third scan clock signal, and a second electrode connected to a third scan output node which outputs a third scan signal; and
a fourth scan buffer transistor including a gate electrode connected to the first control node, a first electrode which receives a fourth scan clock signal, and a second electrode connected to a fourth scan output node which outputs a fourth scan signal, and
wherein the scan hold transistor includes a gate electrode connected to the inverted control node, a first electrode which receives the first low voltage, and a second electrode connected to the first to fourth scan output nodes.

16. The display device of claim 14, wherein each of the plurality of pixels includes:
a first pixel transistor including a gate electrode connected to a first pixel node, a first electrode which receives a first power voltage, and a second electrode connected to a second pixel node;
a second pixel transistor including a gate electrode which receives a scan signal of the plurality of scan signals, a first electrode which receives a data signal of the plurality of data signals, and a second electrode connected to the first pixel node;
a third pixel transistor including a gate electrode, a first electrode which receives an initialization voltage, and a second electrode connected to the second pixel node;
a storage capacitor including a first electrode connected to the first pixel node and a second electrode connected to the second pixel node; and
a light emitting element including a first electrode connected to the second pixel node and a second electrode which receives a second power voltage.

17. The display device of claim 16, wherein the gate electrode of the third pixel transistor receives the scan signal.

18. The display device of claim 16, wherein the individual circuit further includes:
a plurality of sensing buffer transistors which output a plurality of sensing clock signals as a plurality of sensing signals in response to the voltage of the first control node; and
a sensing hold transistor which maintains the plurality of sensing signals at the first low voltage in response to the voltage of the inverted control node.

19. The display device of claim 18, wherein the gate electrode of the third pixel transistor receives a sensing signal of the plurality of sensing signals.

20. The display device of claim 14, wherein the common circuit includes:
a carry buffer transistor which outputs a carry clock signal as a carry signal in response to the voltage of the second control node; and
a carry hold transistor which maintains the carry signal at a second low voltage in response to the voltage of the inverted control node.
